(19) United States
(12) Patent Application Publication
(10) Pub. No.: US 2024/0045406 A1
(43) Pub. Date: Feb. 8, 2024

(54) SYSTEM, PLATFORM, AND METHODS FOR NEURAL NETWORK ENABLED BLOCKCHAIN-BASED PRODUCTION

(71) Applicant: Syncfab Co., (US)

(72) Inventor: Jeremiah Goodwin, Santa Monica, CA (US)

(21) Appl. No.: 18/379,655

(22) Filed: Oct. 13, 2023

Related U.S. Application Data
(63) Continuation-in-part of application No. 18/125,720, filed on Mar. 23, 2023.
Application No. 18/125,720 is a continuation-in-part of application No. 16/731,840, filed on Dec. 31, 2019, now abandoned.
(60) Provisional application No. 62/917,788, filed on Dec. 31, 2018.

(51) Int. Cl. G05B 19/418

(52) U.S. Cl. CPC G05B 19/4183; G05B 19/41865

(57) ABSTRACT

A supervisory production system for enabling production initiation and tracking and for securing production progress between upstream and downstream production systems and request systems by receiving production capacity entries and production update entries, converting them into production capacity nodes and production update nodes, and comparing the production capacity nodes and production update nodes to the production requirement and progress nodes, distributing circulation data parcels based on the results, and tokenizing the production to ensure production authenticity and integrity.

### PRIORITY CLAIM

This U.S. Non-provisional application is a continuation-in part of and claims the benefit of and priority to U.S. non-provisional application Ser. No. 18/125,720, filed Mar. 23, 2023, which in turn is a continuation-in part of and claims the benefit and priority to U.S. non-provisional application Ser. No. 16/731,840, filed Dec. 31, 2019, which in turn claims the benefit and priority to U.S. provisional application 62/917,788, filed Dec. 31, 2018. The above referenced applications are fully incorporated herein as if restated in their entirety.

### SUMMARY

In one embodiment, the exemplary system is a supervisory production system for enabling production initiation and tracking, securing production process, and ensuring production completion. The system described here may be directed to, among other things, the physical and/or digital production of parts, materials, units, and products. The supervisory production system may be configured to engage or encompass sub-systems, including production systems and request systems, were production systems produce production bases on requests received from request systems. Initiation of production falls under the domain of the supervisory production system, which determines whether production should or should not be initiated based on various factors, as will be explained.

The supervisory production system processes the production capacities of the production systems based on category, parameter, and magnitude data relations, encoding the same as “nodes”. Examples of other system attributes encoded as nodes include requirement information pertaining to requests made by request systems, updates on the production directed to satisfying the request requirements, the relationships between production systems, data profiles for the production systems and request systems. Another example of a dedicated node is the embedding of a part, material, unit, or products production history into a node—this production node may in turn be encoded in new nodes if the referenced part, material, unit, or product is in turn incorporated into another part, material, unit, or product. Thus, nodes may exist in a hierarchical relationship such that some nodes operate as “parents” or “macro-nodes” with respect to “children” or “micro-nodes”.

Nodes, which may have uniform formatting, may be compared for correspondence or matching with other nodes created by the supervisory production system. Such comparison for correspondence or matching may occur via expert systems, or achieved using neural networks, which are in turn specially designed to handle node-based data because of their own nodal architecture. In addition, the neural networks may create the nodes by receiving entry data into their various streams; this entry data may be obtained from confirmation devices which are entered directly into the neural network input streams or first saved to various dedicated databases, included distributed databases such as blockchain. The neural networks may be configured to handle hierarchical structures of macro and micro nodes by identifying that a micro node may have data and structure sufficiency even when removed, isolated, or separated from its macro node, although it is possible that the macro node may not have data and structure sufficiency if its micro nodes are removed, isolated, or separated. In addition, the nodes may indicate their position within the macro/micro node structure and the neural networks may detect those positions. The neural networks may divert micro nodes into separate streams, or may receive a macro node in one stream, process the nodal relationships, and then divert the micro nodes into sub-streams.

Nodes may be comprised of database data, with relationships between the data formatted so as to be easily entered and processed by neural networks. The data may be organized categorically, with features or attributes encoded as parameters, and with magnitudes assigned or determined for each parameter. The nodes may be encrypted with decryption keys provided only to relevant parties. Further, encryption may occur in phases, such that the nodes may at first be unencrypted at one time period, then encrypted vis-à-vis a first set of decryption keys in a second time period, and then encrypted vis-à-vis a second set of decryption keys in a third time period, and then finally decrypted entirely in a fourth time period. Encryption may occur within databases describing or otherwise denoting the nodes, or on the production blockchains.

Correspondence of nodes, say between a first node and a second node may be a determination of identicality, such as if a category, parameter, and magnitude of the first node is identical to the category, parameter, and magnitude of the second. Correspondence may also be a determination of similarity, such as if a category, parameter, and magnitude of the first are not considered equal in utility, function, or value to the second, even if not identical. Correspondence may also be a determination of sufficiency, such as if a category, parameter, and magnitude of the first encompasses and includes through identicality or equality in utility, function, and value another category, parameter, and magnitude—even if the first node has additional categories, parameters, or magnitudes that the second node lacks.

The system may comprise a platform and a set of methods actuated via the platform. The system and platform may be embodied by and the methods may be actuated across a set of computers operating over a network. The platform may comprise separate buyer and supplier portals, with the buyer and supplier portals distinguished based on interface features and system access, or the platform may comprise an omnibus interface in which users may access buyer or supplier features freely. The platform may comprise an account architecture, with each account being associated with a set of sub-accounts, internal and external financial (banking and transaction) accounts, user profiles, account profiles, marketing profiles, and external pages. The financial accounts may include cryptocurrency wallets, particularly wallets dedicated to a cryptocurrency native to the platform.

The system may comprise a database for storing information pertaining to users, accounts, and interactions, such as communications, collaborations, and transactions between users/accounts. The database may be conventional or blockchain-based. In one embodiment, the system comprises a plurality of blockchains, with each blockchain dedicated to a given dataset. In one embodiment, the blockchains are inter-connected, with reference information stored on a first blockchain connected to expansive information on a second blockchain. In another embodiment, the blockchains comprise various levels of public access, with some sub-set of blockchains inaccessible or otherwise unreadable to the public except via encryption keys or sufficient login credentials. In one embodiment, a sub-set of blockchains are coupled to cryptocurrencies, including the cryptocurrency native to the system and platform.

The system may comprise a set of neural networks, with sub-sets of neural networks interlinked via transitioning outputs into inputs, with some sub-sets of neural networks interlinked in a circular manner, such that each neural network receives as input the output of some other neural network in the sub-set. The neural networks may be interoperable with so-called expert systems or other artificial intelligent systems that do not comprise neural networks. The neural networks may be each dedicated to handling a given type of dataset, including visual data such as images and video, audio data such as video and oral communications, text data such as email communications, or combinations thereof, such as drawings, blueprints, computer-generated graphical data, and invoices. A sub-set of neural networks may be dedicated to scanning, detecting, or otherwise receiving, and processing user account information.

The system may comprise a set of input devices, including mouse, trackpad, touchscreen, keyboard, microphone, camera, etc. The system may also include dedicated input devices, such as RFID tracker or other trackers/readers of digital signatures embedded in an electromagnetic field (EM readers). The system may also encompass sensors for any relevant parameter, such as weight sensors, optical sensors, turbidity sensors, pressure sensors, chemical sensors, etc.

In one embodiment, exemplary system architecture may include an EM reader configured to communicate wirelessly with a first set of processors, the first set of processors configured to update one or more databases based on the EM data captured by the EM reader, as well as the time and location of the capture. The EM data captured may be an identity of a new or previously detected supply-chain part, unit, material, or product. A camera may be configured to capture image data corresponding to the part, unit, material, or product, and transmit the image data to a second set of processors, with the second set of processors configured to update one or more databases based on the image data captured by the camera, as well as the time and location of the capture. A text input device may be configured to receive from a user text data pertaining to the part, unit, material, or product and transmit the text data to a third set of processors, with the third set of processors configured to update one or more databases based on the text data received by the text input device, as well as the time and location of the receipt. Other sensors may be similarly configured for detecting part, unit, material, or product parameters and transmit those parameters to a fourth set of processors, which in turn are similarly configured to update databases. The various sensors, EM reader, camera, and text input device may each require or be capable of determining a given user responsible for handling or otherwise operating them at the time of the data capture/receipt. These devices may be coupled to GPS or other location detecting components, as well as time detection components such as digital timekeeping applications. The devices may have fingerprint detection modules for determining a user account associated with the user via fingerprint detection. The devices may have login credential requirements for use or the authentication thereof. The devices may have calibration requirements, with caveat data transmitted if the calibration periods have elapsed.

In one embodiment, the exemplary system may associate the various sensor feedback data, EM data, image data, and text data to correspond to a single part, unit, material, or product entry. In one embodiment, the exemplary system may compare the status of the entry with a pre-determined or formulated schedule to determine if the part, unit, material, or product has satisfied a pre-determined status milestone. In one embodiment, the exemplary system may determine whether a given feature, as detected or otherwise determined via the EM, image, or text data matches a blueprint, specification, or other pre-determined quality requirement. Status milestones may correspond to the level of completion of a part, unit, material, or product. Quality requirements may correspond to endurance, efficacy, appearance, or any other desirable quality separate from the mere completion status.

The satisfaction of one or more status milestones and/or quality requirements may be detected by a milestone and requirements module, and thereafter a satisfaction protocol may be actuated via a transaction actuation module. A satisfaction protocol may include a script comprising various commands or instructions, with these commands or instructions previously encoded in the system, agreed to by users of the platform, or agreed to specifically between two separate users of the platform and parties to a given transaction. The commands and instructions with their associated predicates may be embedded in a platform contract, including a native crypto-currency contract. The commands and instructions may include the transmission of payment from one internal or external account to another, or the imposition of a penalty on an internal or external account. Predicates of the commands and instructions may be any status milestone or quality requirement.

As discussed previously, neural networks may be invoked in the processing of the sensor, EM, image, and text data to determine whether the quality requirement or status milestone has been reached. Inputs to these neural networks may include forms, invoices, written contracts, and/or recordings of spoken agreements. Additional inputs may include industry standards and/or government regulations, as embedded, encoded, or otherwise present in standardized forms or websites.

In one embodiment, an exemplary system may be configured to receive, via the platform, communications between users, particularly buyers and suppliers. These communications may include various questions and requests, and the sharing of drawings or other documents. The system may be configured to determine, via a communication adequacy module, whether communications transmitted by a first user to a second user are adequately answered or addressed by the second user. Adequacy here may be determined via so-called expert systems, in which entry fields of a previously established or newly submitted form are determined to be populated or non-populated, or via neural networks, which receive both sets of communications and, based on previous training together with continued training via buyer feedback, rate the response communications. If communications are determined inadequate, the platform may share the determination of inadequacy with the supplier.

Adequacy may be based on the size or length of the response communication, the timeliness of the communication, the completeness of the communication, and/or the time spent by the supplier in creating the response communication. In this manner, robust response communications may be deemed more adequate than superficial response communications, fast communications may be deemed more adequate than slow communications, complete communications may be deemed more adequate than incomplete communications, etc.

In one embodiment, the system ranks and the platform displays the ranking of suppliers based on their communication adequacy. In one embodiment, adequacy data is saved to one or more databases, including a blockchain-based database. In this embodiment, native crypto-currency may be programmed to determine adequacy events, (i.e., a determination of a present or history of adequate communication) and transfer cryptocurrencies or other financial incentives to internal or external financial accounts belonging to the supplier determined to possess the adequate communication. In this manner, suppliers are rewarded for adequate communication regardless of whether buyers move forward with transactions or not.

In one embodiment, an exemplary system may comprise one or more transaction potential neural networks. Transaction potential neural networks may be configured to detect, based on processing internal and external financial accounts and buyer payment history as stored in transaction databases, whether buyers are able and likely to adequately pay for transactions involving suppliers. The transactions involving the suppliers are detected by processing the communications between the buyers and suppliers. If the system determines that the buyer is requesting information pertaining to a transaction for which the buyer is unable to or unlikely to adequately pay, the system may transmit a warning to the buyer and/or the supplier; this enables the supplier to be on notice that the presently discussed transaction is at best hypothetical, which therefore enables suppliers to pay more attention to transactions which are likely to occur, thereby increasing the efficiency of the system. Similarly, the transaction potential neural networks may be configured to determine whether a supplier is likely to adequately supply the parts, units, materials, and products in a transaction based on an analysis of the machinery and labor available to the supplier. This analysis may utilize image data of the supplier location or entries in the supplier account page, as well as the history of past transactions between the supplier and other buyers.

Additionally, the transaction potential neural network may determine whether the supplier has adequate relationships with other suppliers in order to ensure that the supplier can quickly obtain the materials or parts necessary to supply the parts, units, or products required by the transaction. The possession of such relationships may be determined by processing past communications and transactions between the supplier and other suppliers.

If the transaction potential neural network determines that the requests for production communication from the buyer to the supplier are unlikely to be met by the supplier, then the system will alert the buyer of this fact, enabling the buyer to direct procurement efforts toward other suppliers. Here, supply adequacy entails the meeting of quality requirements as well as status milestones.

In another embodiment, transaction potential neural networks determine supply adequacy not merely for actual communications between buyers and a given supplier, but also for that supplier based on communications between buyers and other suppliers; this way, the supplier will be informed whether their machines and labor are sufficient to handle such hypothetical transactions. The transaction potential neural network may be configured to inform the supplier what areas the supplier needs to improve in order to accept such transactions. For example, the transaction potential neural network may advise on an increase in labor force and/or machines. As another example, the transaction potential neural network may advise on the establishment of relationships with up-stream suppliers. This transaction potential neural network behavior encourages advancement of the entire ecosystem by increasing the competency and skill-set of suppliers across channels desirable to buyers.

In one embodiment, an exemplary system may comprise one or more supervisory neural networks. Supervisory neural networks may be configured to receive as input the output of other neural networks and/or expert systems, or to process data that is not otherwise processed by other artificial intelligent systems. The purpose of the supervisory neural networks is to determine points of conflict, delay, failures to meet expectations, and other problems and inefficiencies in the supply chain. Supervisory neural networks are designed to examine the ecosystem as a whole, but may also be used to assist individual users or facilitate individual transactions.

The supervisory neural networks may include natural language processing to process buyer and/or supplier feedback. The supervisory neural networks may be configured to detect patterns of adequacy or inadequacy in communications between buyers and/or suppliers. The supervisory neural networks may be configured to detect patterns in failures to reach status milestones or failures to meet quality requirements for parts, units, materials, or products.

The data processed by the supervisory neural networks may include timestamps to assist in pattern recognition. For example, if the supervisory neural networks determine that there is a relationship between the communications between a first supplier and other suppliers, and that the materials or parts supplied by the other suppliers to the first supplier are incorporated into parts, units, or products which have failed to reach status milestones, then the supervisory neural network may determine that the failure to reach status milestones was due to procrastination in communicating with the up-stream suppliers, and subsequently inform the supplier to initiate communications sooner during production for future transactions.

The supervisory neural networks may track the frequency and reasons behind status milestone and quality requirement failures, summarize these facts graphically, and report them to administrators of the platform. Such reports may be distributed by a platform communication module to all buyers and suppliers so remind buyers and suppliers of best practices, inform them as to deficiencies in their peers, and advise them to avoid making similar mistakes. In this manner, the efficiency of the ecosystem as a whole is improved.

In one embodiment, an exemplary system may comprise machine and labor tracking methods to determine when machines are being overused or in need of repair, or whether labor is being overworked and therefore at risk of injuries or mistakes. The tracking methods may include processing labor timesheets, image data revealing the number of hours a given labor unit works, whether the labor unit wears adequate protective gear, etc. The tracking methods may also include tracking the electrical use of machines as heuristics for use via current sensors, the duration of use of the machines, and the frequency of maintenance checks and repair. The frequency of maintenance checks and repairs may be captured by the scanning of EM signatures of machines or machine parts by maintenance workers. Use of machines and labor may also be inferred by the details and transactions undertaken by the suppliers. The captured data described here, along with actual reports of injuries or machine malfunctions, may be processed by machine and labor tracking neural networks, which may be utilized to predict injures and malfunctions based on streaming data.

### BRIEF DESCRIPTION OF THE DRAWINGS

FIG. 1 shows an exemplary system architecture.

FIG. 2 shows an exemplary system process.

FIG. 3 shows an exemplary system architecture.

FIGS. 4-16 show exemplary system processes.

### DETAILED DESCRIPTION OF THE DRAWINGS

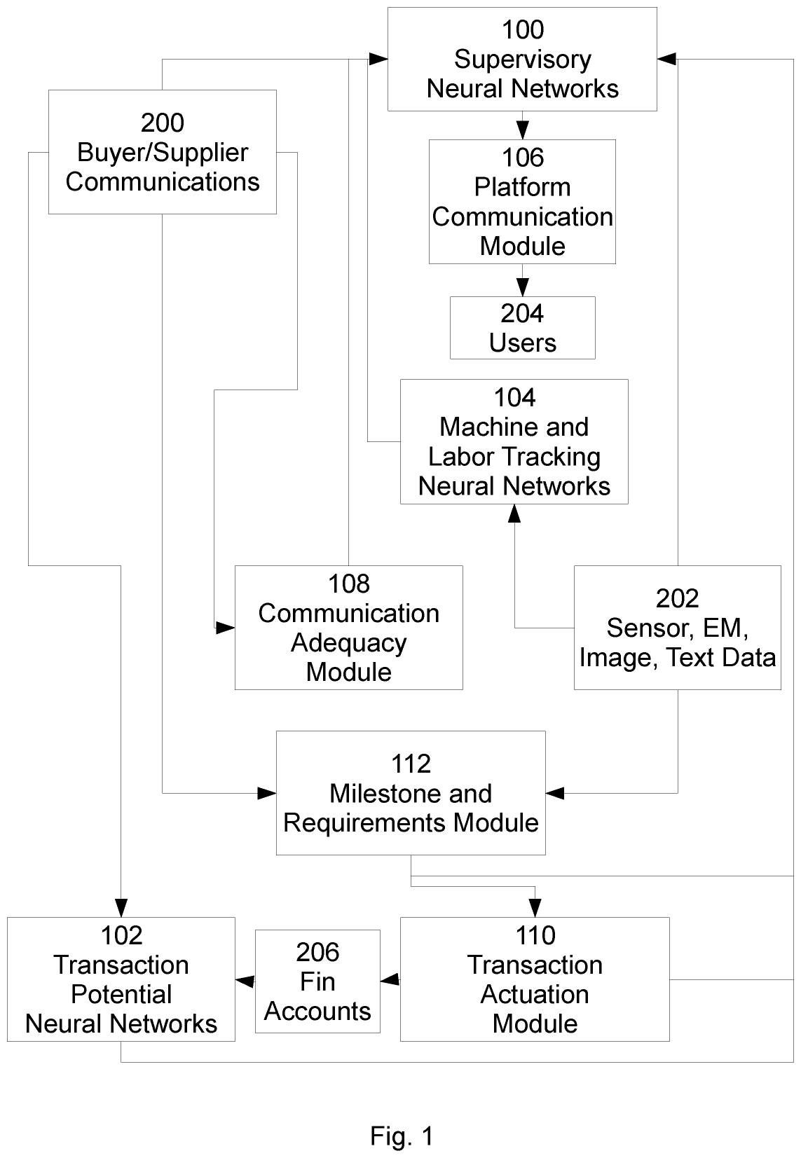

As shown in FIG. 1, the supervisory neural networks 100 are trained on data received from the transaction actuation module 110, the milestone and requirements module 112, the buyer/supplier communications 200, the machine and labor tracking neural networks 104, the sensor, EM, image, and text data 202, the transaction potential neural networks, and the communication adequacy module 108. This data may be initially labeled by administrators, but continued input of these data streams enables self-supervised training. The supervisory neural networks produce graphical reports which are transmitted to the platform communication module 106, which then transmit advise, suggestions, and warnings to users, including buyers, suppliers, and administrative users.

Buyer/Supplier communications 200, sensor, EM, image, and text data 202 are used by the milestone and requirements module 112 to determine what status milestones and quality requirements were implicit or explicit in a transaction agreement between a buyer and a supplier, and what status milestones and quality requirements have been met. The satisfaction of these milestones and requirements, or lack thereof, is transmitted to the transaction actuation module 110, which processes payment from the buyer to the supplier, or imposes penalties on the supplier. Such processing and impositioning is applied to user financial accounts 206.

The buyer/supplier communications 200 are also processed by the communication adequacy module 108, which determines whether supplier responses to buyer queries are adequate. Adequacy may be incentivized by the processing of payments and impositioning of penalties to user financial accounts (not shown).

The machine and labor tracking neural networks 104 may receive sensor, EM, image, and text data 202 from a supplier location to predict when machines need to be maintained or labor needs to be trained for safety compliance.

The transaction potential neural networks 102 may determine, based on buyer/supplier communications 200, buyer financial accounts 206, and sensor, EM, image, and text data whether buyers are capable of paying for a given transaction and whether suppliers are capable of meeting milestones and quality requirements for the given transaction.

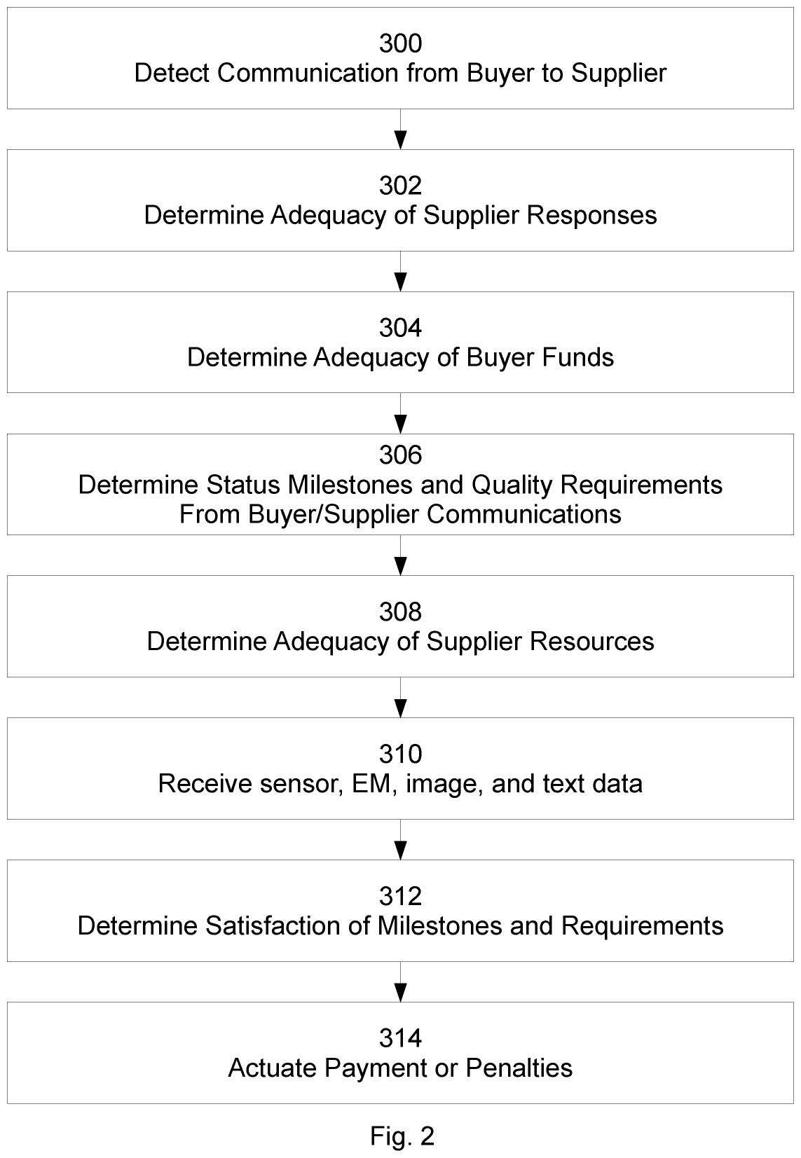

As shown in FIG. 2, the system processors may be programmed to detect communications on the platform between a buyer and a supplier 300. The communication adequacy module may be then determine whether the supplier responses were adequate 302. The milestone and requirements module may determine the milestones and requirements of the pending transaction 306 by processing the communications. The transaction potential neural networks may determine whether the supplier is able to satisfy the milestones and requirements 308. The milestone and requirements module may receive various data pertaining to production 310, such as sensor data, electromagnetic signatures corresponding to parts, units, materials, or products, image data depicting features of the same, and text data describing the same, and then determine whether the milestones and requirements are met 312. If they are met, then the transaction module may actuate payment; if not, it may impose penalties on the supplier 314.

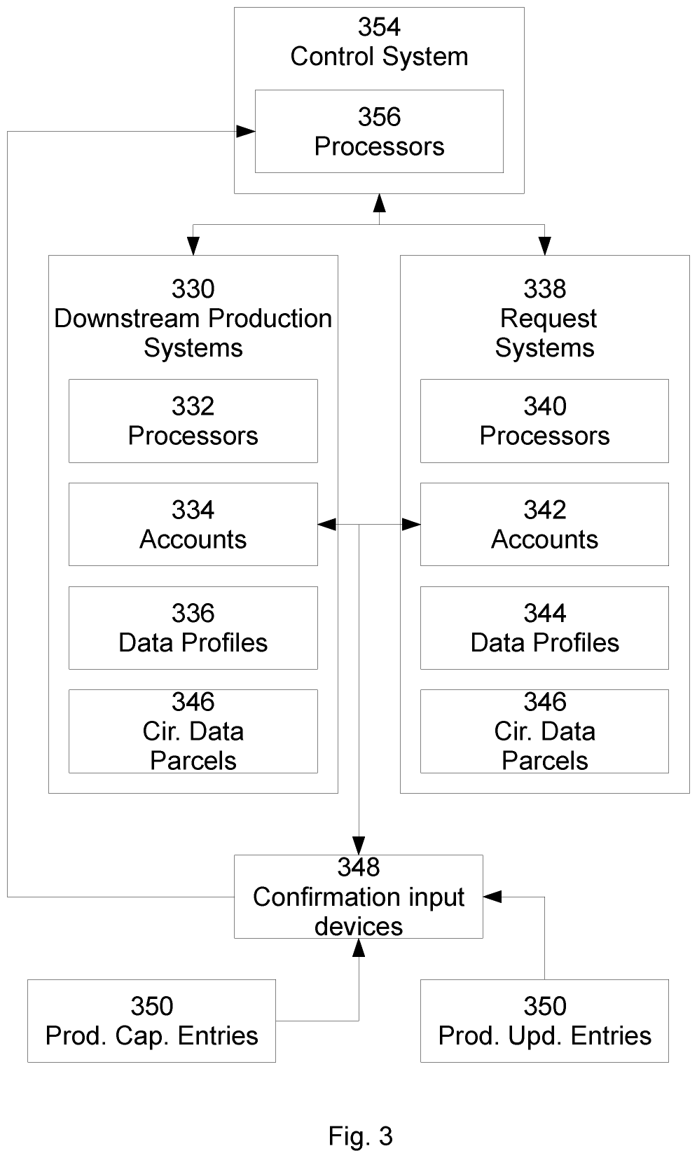

As shown in FIG. 3 and in one embodiment, a supervisory production system (or sometimes simply, “the system”) may be configured to enable production initiation, and track and secure production progress. The supervisory production system may comprise downstream production systems 330, with the downstream production systems comprising production system processors 332, production system accounts 334, and production system data profiles 336; request systems 338, with the request systems comprising request system processors 340, request system accounts 342, and request system data profiles 344; circulation data parcels 346, with the circulation data parcels being assigned to production system and request system accounts; confirmation input devices 348, with the confirmation input devices configured to detect or receive production capacity entries 350 and production update entries 352; a control system 354, with the control system comprising control processors 356. Production systems may use their capacities, including but not limited to their processors, to fulfill the production requests, where the requested production may enable the request systems to in turn provide production for other request systems. In this sense, production and request systems are relative in that a first system may operate as a request system for a second system and the second system may operate as a production system for the first system, but the first system may operate as a production system for a third system and the third system may operate as a request system for the first system. One set of relative terminology is the identification of production and request systems in an engagement, but a broader terminology is the identification of upstream production systems, downstream production systems, and request systems. Thus, there may be a chain of production and request systems, and the chain may even be substantially circular. The management of this chain by the supervisory production system increases the efficiency and efficacy of production as it moves across the chain.

The control system may also comprise a control or administrative account.

Circulation data parcels in particular coordinate the flow of production across the production chain by indicating the relative of significance of various production features, such as the parts, materials, units, and products of production themselves, as well as the rates or manners in which they are produced. The circulation data parcels are capable of indicating the aforementioned significance because they are individually commonly formatted and set as equal within the system, and yet may contain or encode within them data pertaining to parts, units, materials, and products, and their rates and manners of production. Indeed, the circulation data parcels may be cryptocurrency tokens. The circulation data parcels may operate as or be embedded in cryptocurrency units assigned to production system and request system accounts, and may be allocated, transmitted, and assigned across systems such that various production features captured by one system may reflected by the circulation data parcels captured by another system. Because of their uniform formatting, circulation data parcels, individually or in groups, may operate as and be treated as circulation data parcel nodes. Data parcels are essentially data sets with functional and programmatic attributes.

The production capacity entries may include resource, equipment, hardware, and software data. The production capacity entries may include worker or user data. The production update entries may include part, unit, material, or product data. The confirmation input devices may include text input devices, with the text input devices configured to receive text descriptions. The confirmation input devices may include image capturing devices. The confirmation input devices may include EM readers configured to detect EM tags. The confirmation input devices may include sensors such as weight sensors, optical sensors, turbidity sensors, pressure sensors, chemical sensors, geographical positioning sensors, time sensors, or fingerprint sensors.

Confirmation input entries may be reflected in the circulation data parcels created to embed them (i.e., track them and secure the information integrity). They may be assigned to the accounts responsibility for submitting the confirmation input entries into the supervisory production system, thereby giving a prioritizational advantage to the request or production systems associated with the submitting account. This prioritizational advantage may be used to assist the associated system in procuring production ahead of other systems.

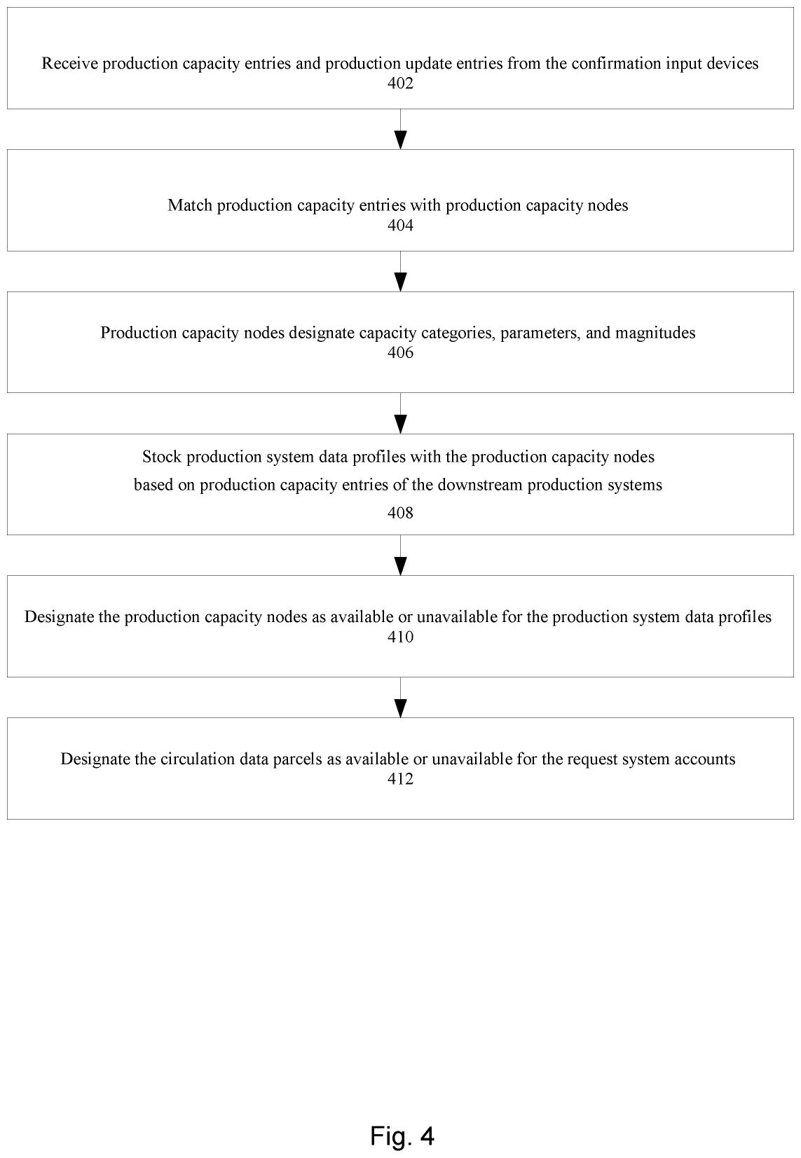

As shown in FIG. 4 and in one embodiment, the control processors may be programmed to: receive production capacity entries and production update entries from the confirmation input devices 402, match production capacity entries with production capacity nodes 404, with the production capacity nodes designating capacity categories, parameters, and magnitudes 406; stock production system data profiles with the production capacity nodes based on production capacity entries of the downstream production systems 408; designate the production capacity nodes as available or unavailable for the production system data profiles 410; and designate the circulation data parcels as available or unavailable for the request system accounts 412.

Availability of production capacity nodes depends on whether those referenced capacities are already being dedicated to handling production with another system, is found deficient due to non-compliance, lack of certification, or for some other reason cannot currently be directed to the present production request.

Matching entries with nodes may be achieved through the use of neural networks, as described elsewhere, or by searching identifying categories, parameters, and magnitudes from the entries and searching for the same in a nodal database.

Stocking system data profiles with nodes may involve adding the system data profile under a control category of the nodes, or it may mean making a copy of the nodes and listing them under the system data profile in a system data profile database. In one embodiment, the nodes may be incorporated into system data profile nodes. The system data profiles may be saved to production blockchains.

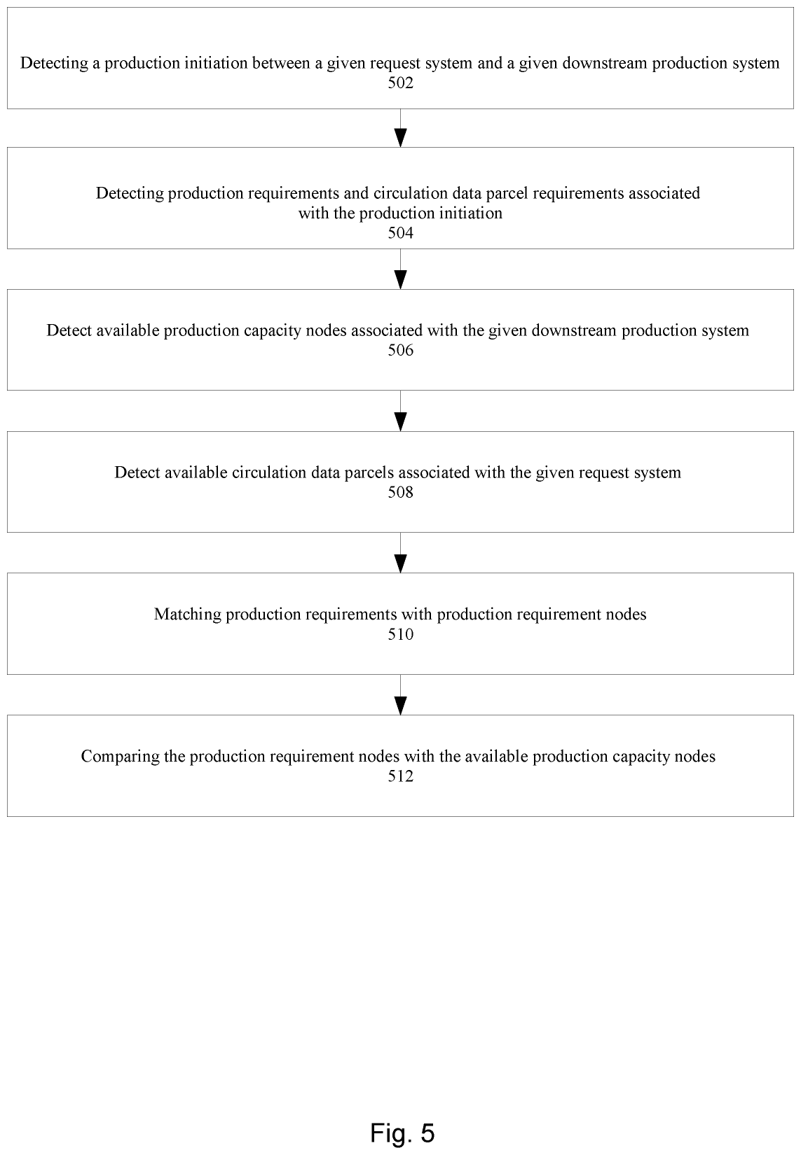

As shown in FIG. 5 and in one embodiment, the control processors may be programmed to enable production initiation by: detecting a production initiation between a given request system and a given downstream production system 502, then detecting production requirements and circulation data parcel requirements associated with the production initiation 504, detect available production capacity nodes associated with the given downstream production system 506, and detect available circulation data parcels associated with the given request system 508; matching production requirements with production requirement nodes 510, with the production requirement nodes designating requirement categories, parameters, and magnitudes; comparing the production requirement nodes with the available production capacity nodes 512.

Similar to production capacity availability, circulation data parcel availability depends on whether and to what degree the circulation data parcels are already being dedicated, or tentatively dedicated, to being subject to production initiations with other production system, or other production initiations with the same production system. Alternatively the circulation data parcels may be unavailable because of non-compliance, lack of certification, or fraud pertaining to a production update or capacity entry, or part, unit, material or product from which the circulation data parcel is derived or to which it is directed.

Detection of various nodal precursors, or the nodes themselves, may be achieved through focused searches by the control system processors. The searches may isolate one or more elements of a data set or node for searching in databases, production blockchains, etc., particularly in sections thereof designating the system profiles which will be ideally stocked with the sought for nodes, or else in more generic “encyclopedia” type databases or sections of the production blockchains in which generic categories, parameters, and magnitudes are interlinked in order to represent the significance thereof.

Production requirements may refer to various features required by the request systems with respect to the requested desired production, such as the timeline of production, the quantity of production, and the quality of production. The production system in turn may impose the circulation data parcel requirements needed in order to validate the production in the context of dedicating the production system's production capacity toward that production. In other words, the circulation data parcel requirements realized by the production system are a function of the prioritization of the given production over alternative production with other request systems. The circulation data parcels identified in the requirements enable the production systems to increase in production capacity by obtaining production thereof from upstream production systems.

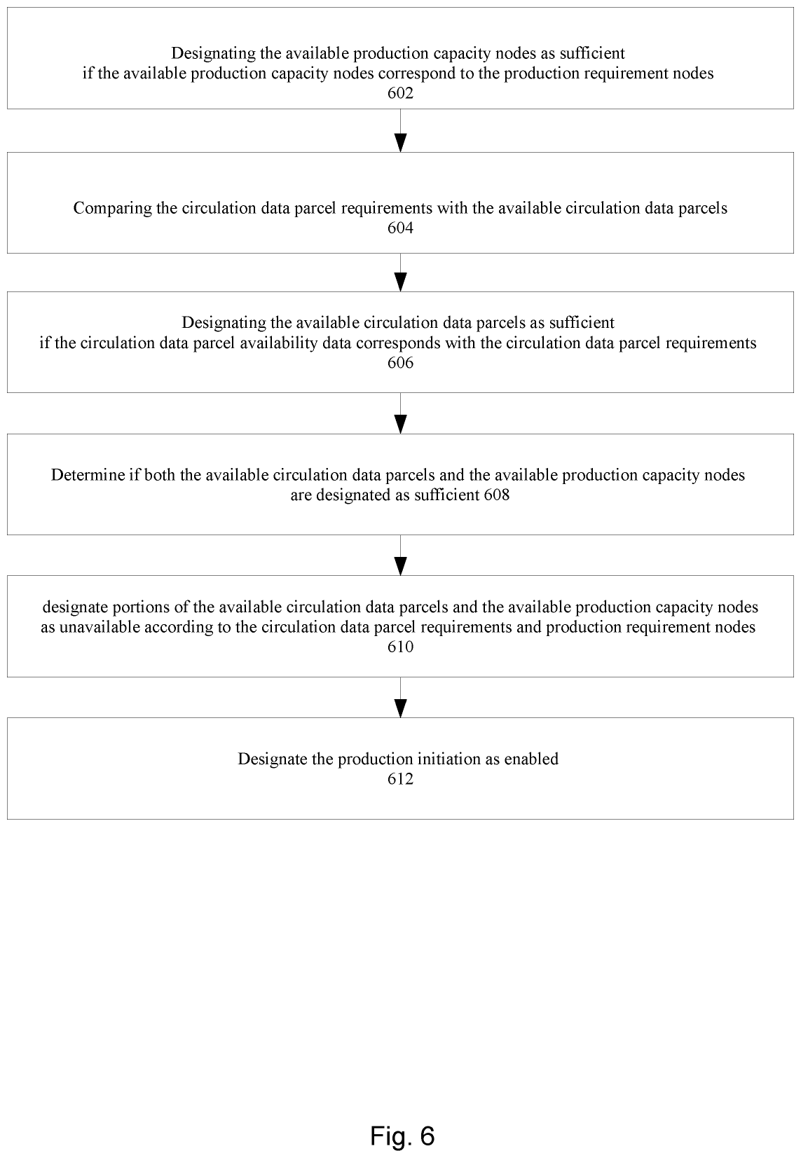

As shown in FIG. 6 and in one embodiment, the control processors may be programmed to enable production initiation by designating the available production capacity nodes as sufficient if the available production capacity nodes correspond to the production requirement nodes 602; comparing the circulation data parcel requirements with the available circulation data parcels 604; designating the available circulation data parcels as sufficient if the circulation data parcel availability data corresponds with the circulation data parcel requirements 606; determine if both the available circulation data parcels and the available production capacity nodes are designated as sufficient 608, then if so, designate portions of the available circulation data parcels and the available production capacity nodes as unavailable according to the circulation data parcel requirements and production requirement nodes 610, and designate the production initiation as enabled 612.

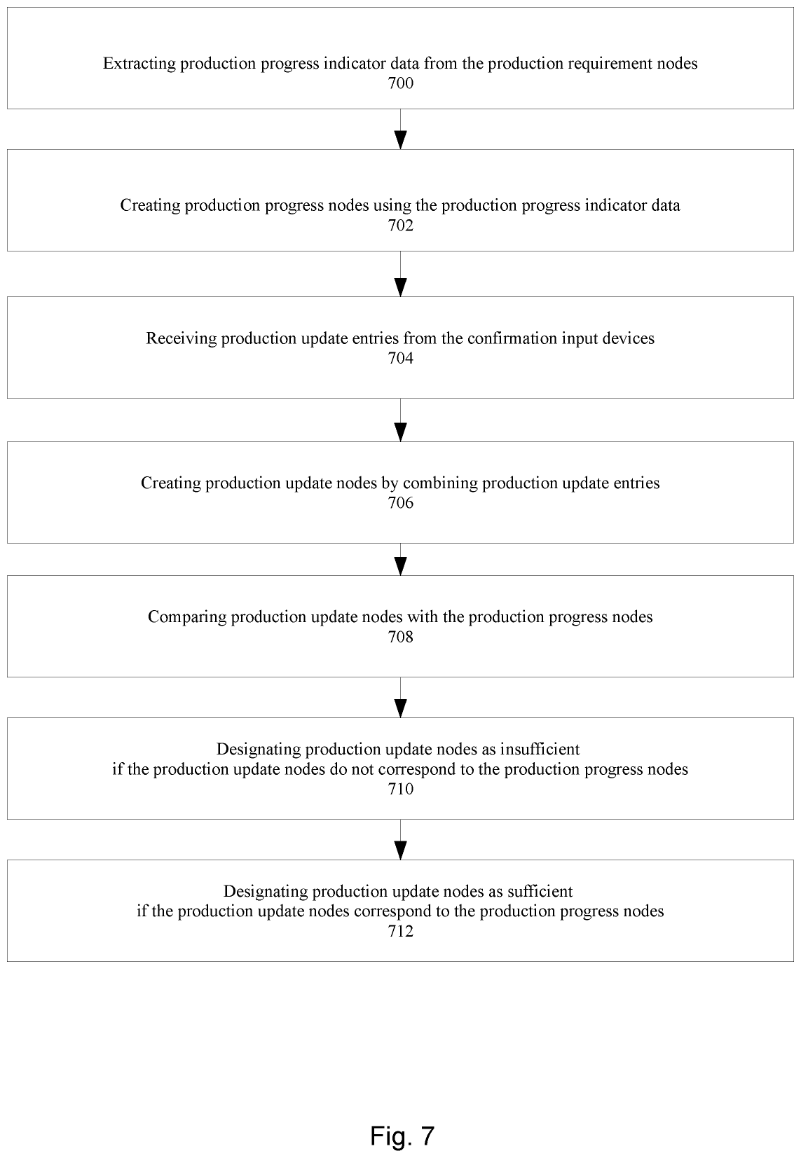

As shown in FIG. 7 and in one embodiment, the control processors may be programmed to track production progress by: extracting production progress indicator data (i.e., precursors to nodal formation comprising principally of category, parameter, and magnitude data referencing to describe the status of parts, units, materials, and productions during development) from the production requirement nodes 700, creating production progress nodes using the production progress indicator data 702, with the production progress nodes designating progress categories, parameters, and magnitudes; receiving production update entries from the confirmation input devices 704, creating production update nodes by combining production update entries 706, with the production update nodes designating update categories, parameters, and magnitudes; comparing production update nodes with the production progress nodes 708; designating production update nodes as insufficient if the production update nodes do not correspond to the production progress nodes 710; designating production update nodes as sufficient if the production update nodes correspond to the production progress nodes 712. Progress nodes may operate as milestones, such as purchase order milestones, extracted from production agreements.

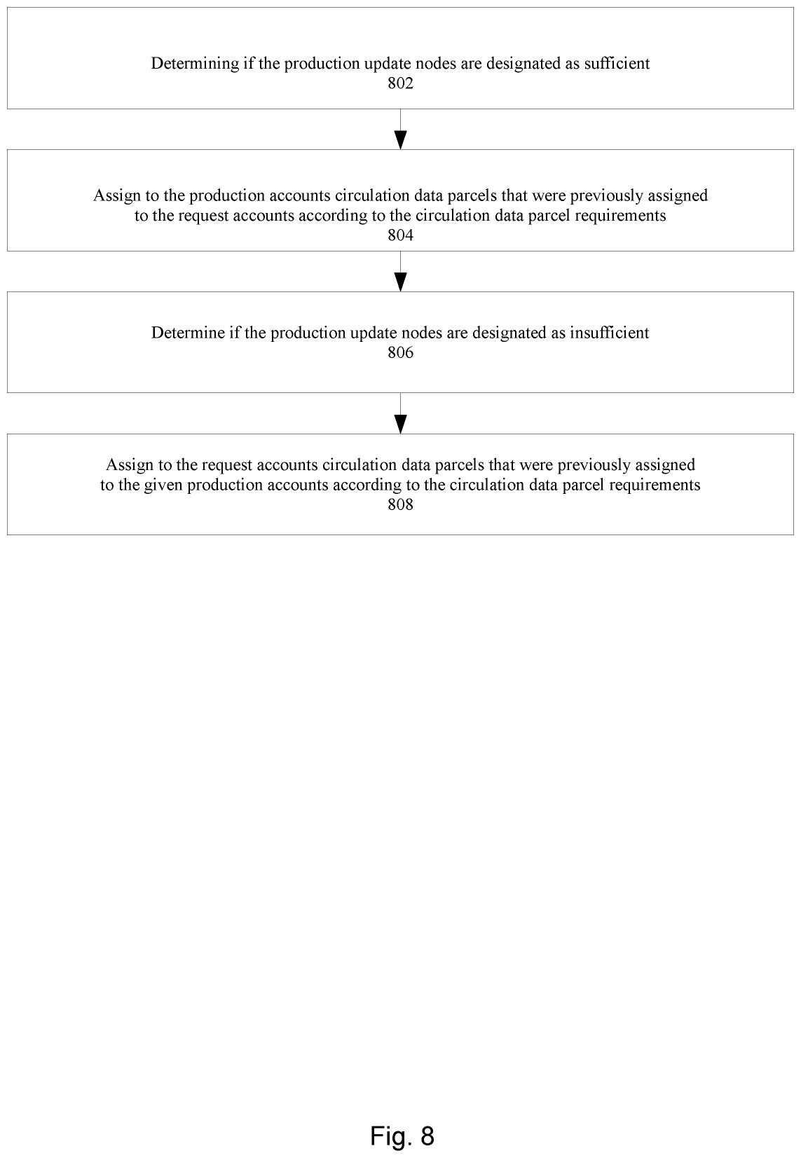

As shown in FIG. 8 and in one embodiment, the control processors may be programmed to secure production progress by: determining if the production update nodes are designated as sufficient 802, then if so, assign to the production accounts circulation data parcels that were previously assigned to the request accounts according to the circulation data parcel requirements 804; determine if the production update nodes are designated as insufficient 806, then if so, assign to the request accounts circulation data parcels that were previously assigned to the given production accounts according to the circulation data parcel requirements 808.

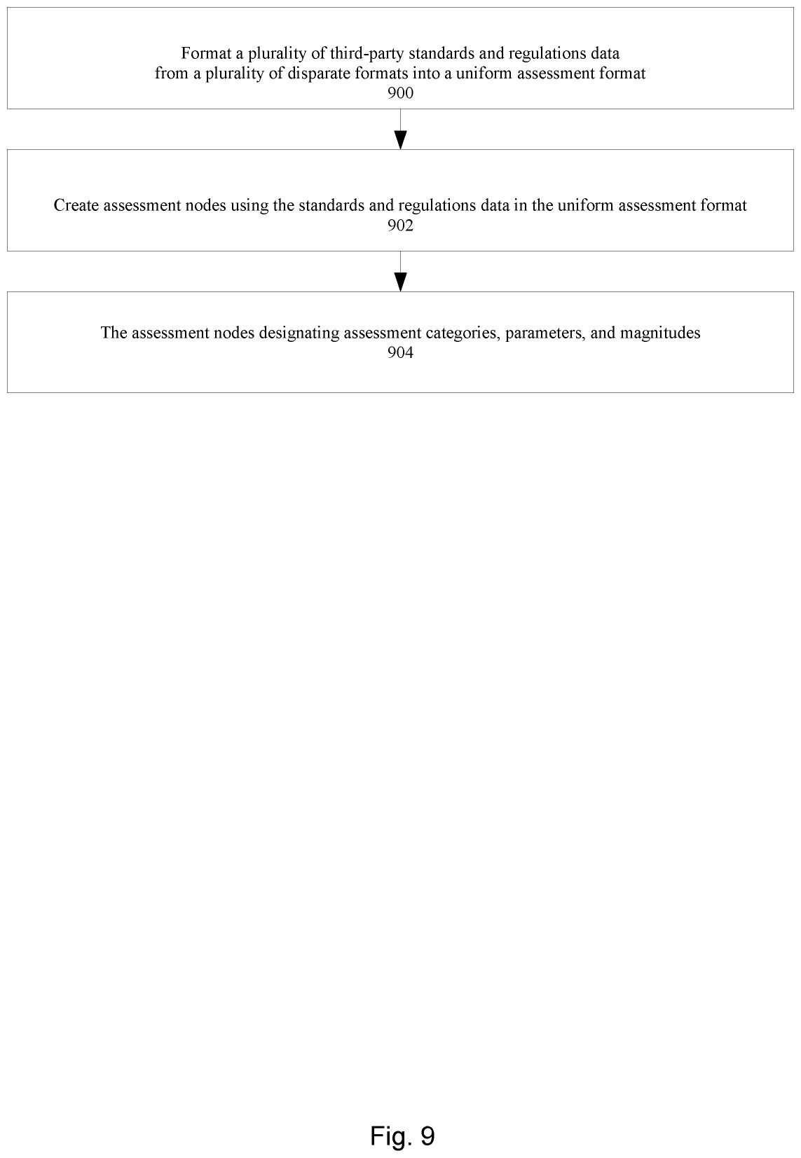

As shown in FIG. 9 and in one embodiment, the control processors may be programmed to format a plurality of third-party standards and regulations data from a plurality of disparate formats into a uniform assessment format 900 and create assessment nodes using the standards and regulations data in the uniform assessment format 902, with the assessment nodes designating 904 assessment categories, parameters, and magnitudes.

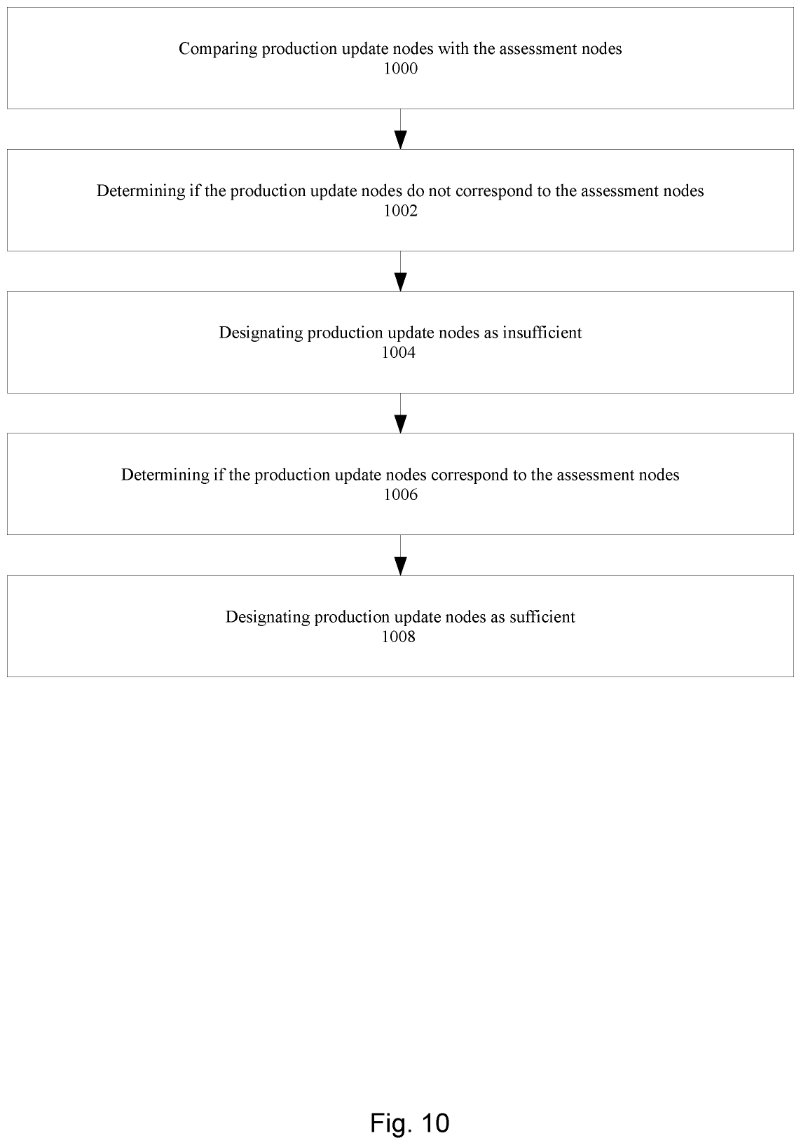

As shown in FIG. 10 and in one embodiment, the control processors may be programmed to secure production progress by comparing production update nodes with the assessment nodes 1000; designating production update nodes as insufficient 1004 if the production update nodes do not correspond to the assessment nodes 1002; designating production update nodes as sufficient 1008 if the production update nodes correspond to the assessment nodes 1006.

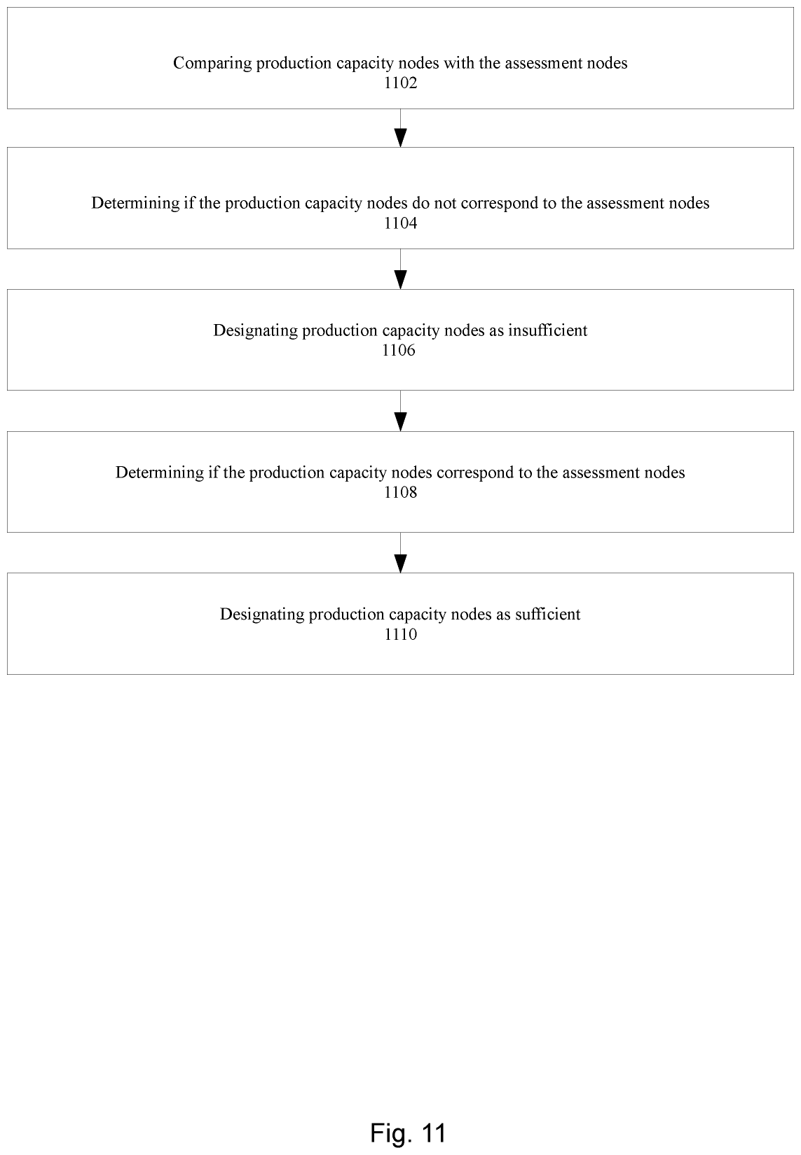

As shown in FIG. 11 and in one embodiment, the control processors may be programmed to enable production initiation by: comparing production capacity nodes with the assessment nodes 1102; designating production capacity nodes as insufficient 1106 if the production capacity nodes do not correspond to the assessment nodes 1104; designating production capacity nodes as sufficient 1110 if the production capacity nodes correspond to the assessment nodes 1108.

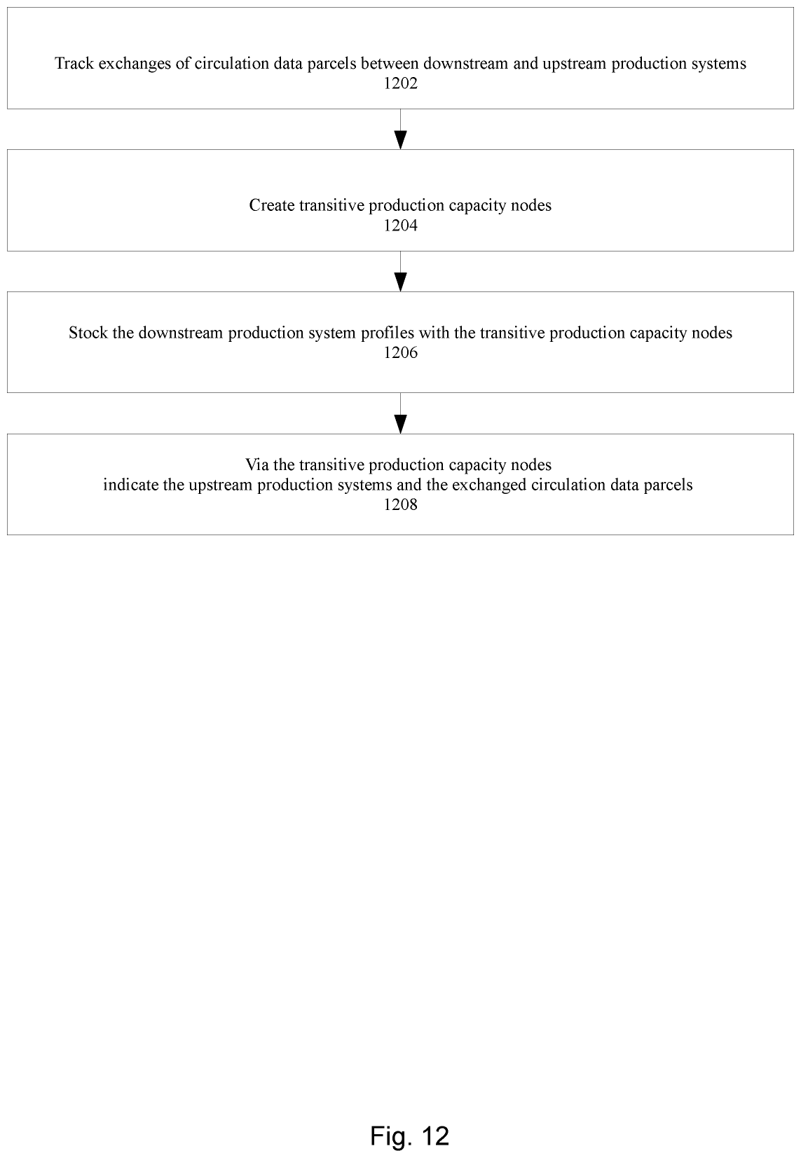

As shown in FIG. 12 and in one embodiment, the supervisory production system may additionally comprise upstream production systems, with the control processors programmed to track exchanges of circulation data parcels between downstream and upstream production systems 1202, create transitive production capacity nodes 1204, and stock the downstream production system profiles with the transitive production capacity nodes 1206; with the transitive production capacity nodes indicating the upstream production systems and the exchanged circulation data parcels 1208. Transitive production capacity nodes thus refer to production capacities that a downstream production system may not itself possess, but which may be possessed with other downstream or upstream production systems. These latter production systems may constitute sub-contractors or suppliers of outsourced materials, finishes, or additional capabilities or capacities.

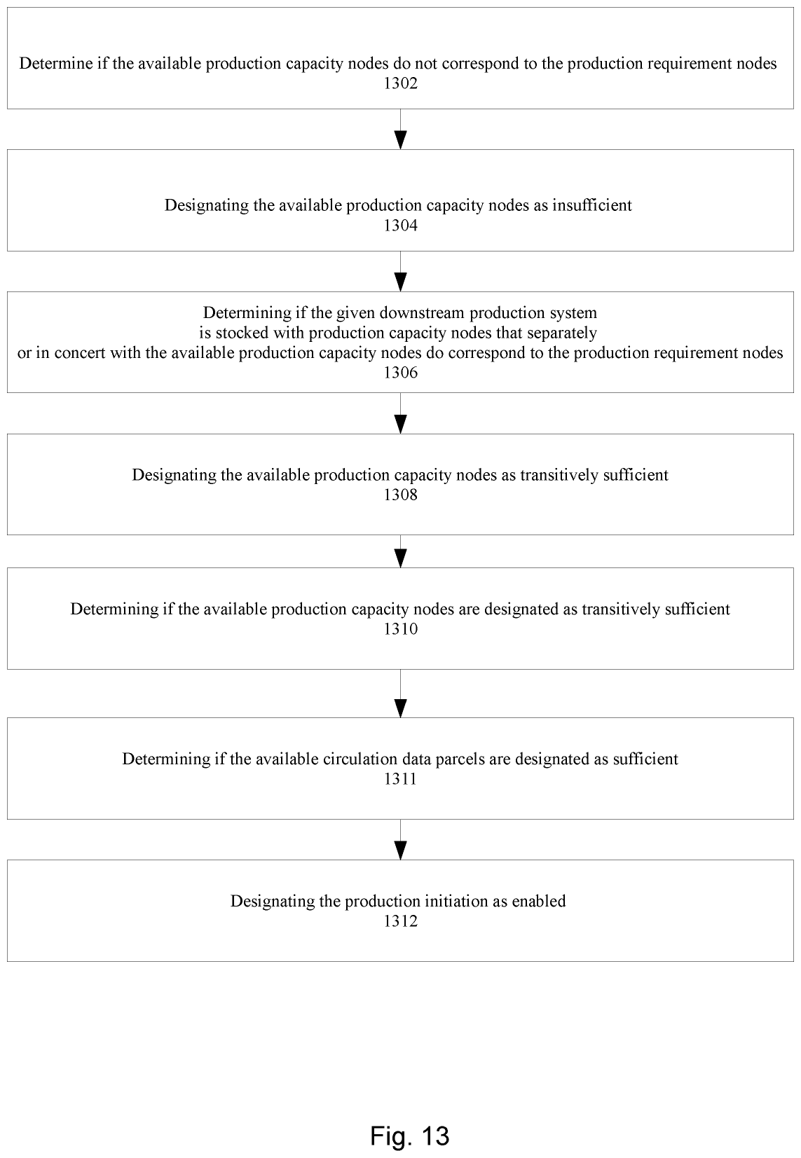

As shown in FIG. 13 and in one embodiment, the control processors may be programmed to enable production initiation by: designating the available production capacity nodes as insufficient 1304 if the available production capacity nodes do not correspond to the production requirement nodes 1302, then determining if the given downstream production system is stocked with production capacity nodes that separately or in concert with the available production capacity nodes do correspond to the production requirement nodes 1306, then designate the available production capacity nodes as transitively sufficient 1308; then designate the production initiation as enabled 1312 if the available production capacity nodes are designated as transitively sufficient 1310 and the available circulation data parcels are designated as sufficient 1311.

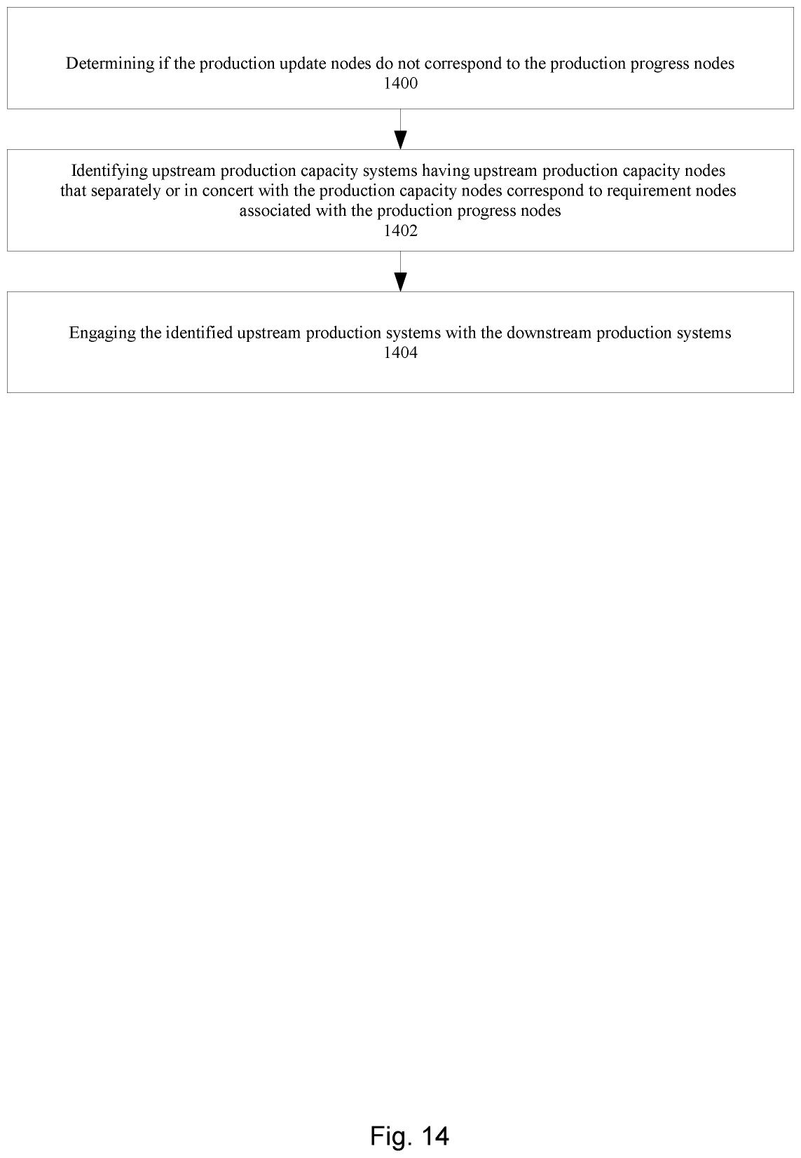

As shown in FIG. 14 and in one embodiment, the control processor may be programmed to secure production progress by: if the production update nodes do not correspond to the production progress nodes 1400, identifying upstream production capacity systems having upstream production capacity nodes that separately or in concert with the production capacity nodes correspond to requirement nodes associated with the production progress nodes 1402, and engaging the identified upstream production systems with the downstream production systems 1404.

In one embodiment, the supervisory system may distinguish between a production system's capabilities, such as milling, turning, bending, cutting, welding, 3d printing, forging, casting, etc., and the present availability (i.e., capacity) of those capabilities based on other factors, such as whether equipment, hardware, software, workers, resources, etc., are available to utilize those capabilities, or whether the same are already dedicated to fulfilling some other work order. The system may process capabilities as “capacities” and then the availability or “capacity” of those capabilities by designating the capacities as available or unavailable. Detection of availability may occur iteratively as the capacities are directed toward one or more projects or endeavors and then confirmed with respect to their status during initiation of future production projects, or all at once each time production preliminaries are initiated.

The system may also distinguish between certifications, which may be granted by third parties such as governmental, educational, industry, for-profit, or non-profit certifying bodies, and compliance with third party rules, standards, and regulations. Certifications may provide some evidence of compliance, and compliance may provide justification for certifications. In one embodiment, the system provides an internal certification based on its detection of compliance. Such certifications as well as evidence of compliance (or lack of compliance) may be saved to dedicated or generic blockchains. Certifications or evidence of suppliance may also provide discounts or other financial rewards via the system's native cryptocurrency or circulation data parcel assignments for use in-system. Compliance may include engineering specification compliance, manufacturing standards and regulations, development standards and regulations, and/or quality control standards and regulations.

In one embodiment, the supervisory production system is configured for tracking, securing, and tokenizing production initiation and production progress. The production update entries may include part, unit, material, or product data, with the part, unit material, or product data including unique identification data and designating a downstream production system responsible for producing or providing the part, unit, material, or product. The production update entries may be associated with users, production or request systems, or the accounts of those who submitted the production update entries. Tokenization of parts may provide a parts pedigree that is tracked, updated, and confirmed on and via the production blockchains. The tokenization may also be embedded in the circulation data parcels, which in turn may function as cryptocurrency tokens for use within the system. Tokenization may adhere to physical or virtual parts, such as digital models or formulae.

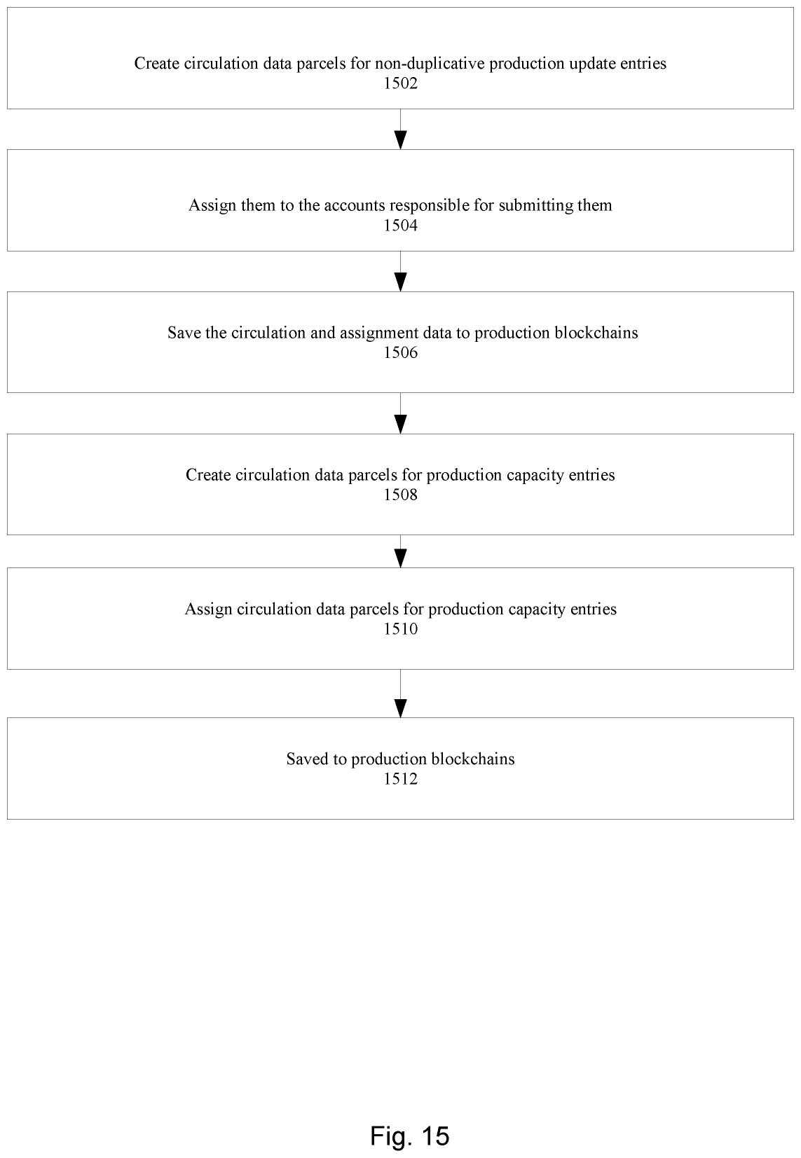

As shown in FIG. 15, the supervisory system may create circulation data parcels for non-duplicative production update entries 1502 and assign them to the accounts responsible for submitting them 1504. Further, the system may save the circulation and assignment data to production blockchains 1506. Similarly, the system create 1508 and assign 1510 circulation data parcels for production capacity entries, which are similarly saved to production blockchains 1512.

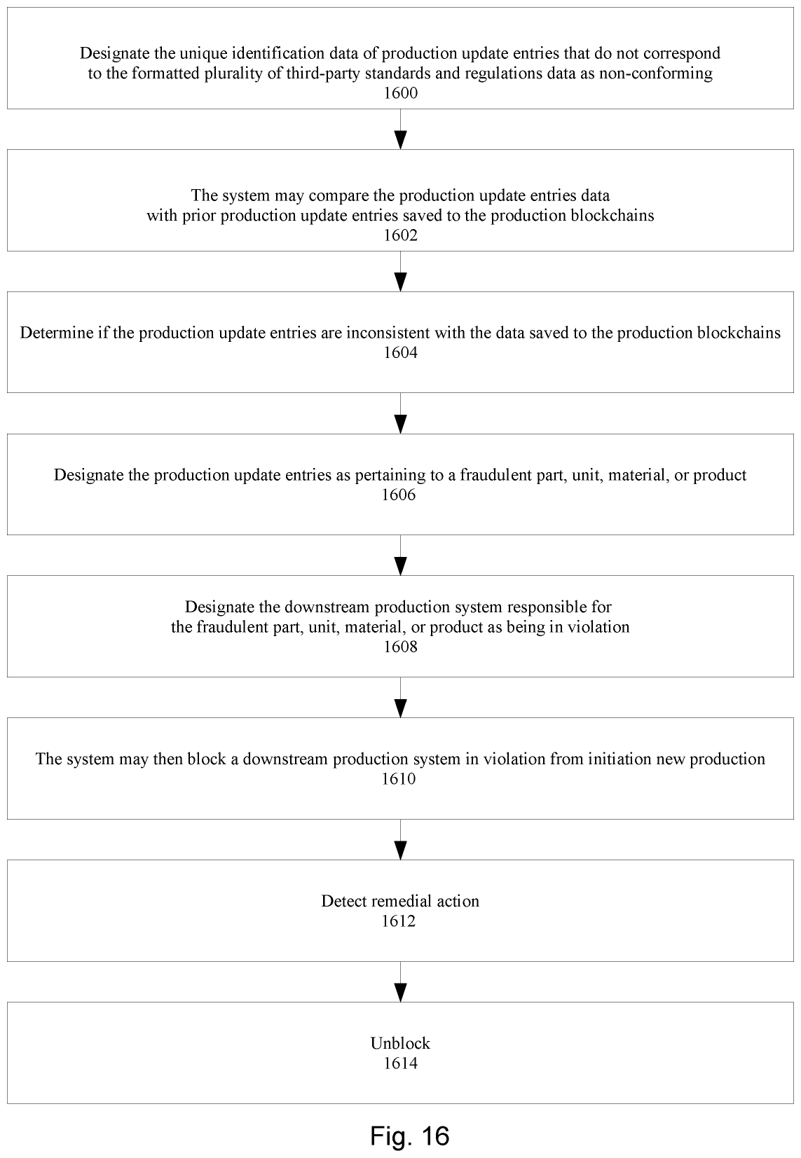

As shown in FIG. 16, the system may designate the unique identification data of production update entries that do not correspond to the formatted plurality of third-party standards and regulations data as non-conforming 1600. The system may compare the production update entries data with prior production update entries saved to the production blockchains 1602, and determine if the production update entries are inconsistent with the data saved to the production blockchains 1604, and then if so, designate the production update entries as pertaining to a fraudulent part, unit, material, or product 1606 and designate the downstream production system responsible for the fraudulent part, unit, material, or product as being in violation 1608. The system may then block a downstream production system in violation from initiation new production 1610 until remedial action is taken 1612 by, for example, fixing or replacing the fraudulent or otherwise defect part, unit, material, or product, and thereafter unblock 1614. Only then may the downstream production system again initiate or otherwise enter into production engagements. Downstream production systems may also be blocked, suspended, or expelled from access to the system depending on the occurrence, type, frequency, and/or degree of violation.

Violations may be designated even if a part, material, unit, or product is authentic but derived from a blocked or otherwise forbidden production system or source, as dictated in the rules and regulations.

In one embodiment, the supervisory production system facilitates so-called “circulation data parcel financing” of production activity, in particular for the maintaining or increasing of production capacity (i.e., capacity itself in terms of possible categories, parameters, and magnitudes of production, but also the availability thereof), via the circulation data parcels. Circulation data parcel financing (or simply, “financing”) via the circulation data parcels may involve the saving of circulation data parcel financing details to the production blockchains and then assigning the circulation data parcels to the production systems the activity of which is being financed. The circulation data parcels and production blockchains may designate the specific production capacities being financed and reference the repayment details (i.e., returning circulation data parcel assignments). The programmatic aspect of the circulation data parcels may in turn trigger the supervisory production system to change ownership or assignment of the circulation data parcels themselves, other circulation data parcels assigned to the same production system, or in the event of insufficiency of circulation data parcels required for repayment, the production capacities financed may themselves be either designated as unavailable until repayment occurs or assigned to a separate system.

In one embodiment, financial institutes may engage with the supervisory productions system by operating as financial production systems with corresponding circulation data parcel associations, financial production system profiles, and financial production system accounts. In this embodiment, circulation data parcel financing operates as a kind of production, and information pertaining to the production may be captured via confirmation devices and result in the creation by the system of the corresponding circulation data parcels which are being used in the financial production.

Circulation data parcel financing via the circulation data parcels may be actuated automatically by the supervisory productions system upon detecting production initiation, correspondence between production updates and production progress, or production completion. If financing occurs in this manner, then the circulation data parcels (or a portion thereof) that would otherwise be assigned from the requesting system to the (downstream) productions system may instead be assigned from the same to the financial production system.

1. A supervisory production system for enabling production initiation and tracking and for securing production progress, with the supervisory production system comprising:
a. downstream production systems, with the downstream production systems comprising production system processors, production system accounts, and production system data profiles;
b. request systems, with the request systems comprising request system processors, request system accounts, and request system data profiles;
c. circulation data parcels, with the circulation data parcels being assigned to production system and request system accounts;
d. confirmation input devices, with the confirmation input devices configured to detect or receive production capacity entries and production update entries;
e. a control system, with the control system comprising control processors, with the control processors programmed to:
i. receive production capacity entries and production update entries from the confirmation input devices;
ii. match production capacity entries with production capacity nodes, with the production capacity nodes designating capacity categories, parameters, and magnitudes;
iii. stock production system data profiles with the production capacity nodes based on production capacity entries of the downstream production systems;
iv. designate the production capacity nodes as available or unavailable for the production system data profiles;
v. designate the circulation data parcels as available or unavailable for the request system accounts;
vi. enable production initiation by:
1. detecting a production initiation between a given request system and a given downstream production system, then detecting production requirements and circulation data parcel requirements associated with the production initiation, available production capacity nodes associated with the given downstream production system and available circulation data parcels assigned to the given request system;
2. matching production requirements with production requirement nodes, with the production requirement nodes designating requirement categories, parameters, and magnitudes;
3. comparing the production requirement nodes with the available production capacity nodes;
4. designating the available production capacity nodes as sufficient if the available production capacity nodes correspond to the production requirement nodes;
5. comparing the circulation data parcel requirements with the available circulation data parcels;
6. designating the available circulation data parcels as sufficient if the circulation data parcel availability data corresponds with the circulation data parcel requirements;
7. if both the available circulation data parcels and the available production capacity nodes are designated as sufficient, then designating portions of the available circulation data parcels and the available production capacity nodes as unavailable according to the circulation data parcel requirements and production requirement nodes and designating the production initiation as enabled;
vii. track production progress by:
1. extracting production progress indicator data from the production requirement nodes, creating production progress nodes using the production progress indicator data, with the production progress nodes designating progress categories, parameters, and magnitudes;
2. receiving production update entries from the confirmation input devices, creating production update nodes by combining production update entries, with the production update nodes designating update categories, parameters, and magnitudes;
3. comparing production update nodes with the production progress nodes;
4. designating production update nodes as insufficient if the production update nodes do not correspond to the production progress nodes;
5. designating production update nodes as sufficient if the production update nodes correspond to the production progress nodes;
viii. secure production progress by:
1. if the production update nodes are designated as sufficient, then assigning to the production accounts circulation data parcels that were previously assigned to the request accounts according to the circulation data parcel requirements; and
2. if the production update nodes are designated as insufficient, then assigning to the request accounts circulation data parcels that were previously assigned to the given production accounts according to the circulation data parcel requirements.

2. The supervisory production system of claim 1, with the circulation data parcels being cryptocurrency tokens.

3. The supervisory production system of claim 1, with the production capacity entries including resource, equipment, hardware, and software data.

4. The supervisory production system of claim 1, with the production capacity entries including worker or user data.

5. The supervisory production system of claim 1, with the production update entries including part, unit, material, or product data.

6. The supervisory production system of claim 1, with the confirmation input devices including text input devices, with the text input devices configured to receive text descriptions.

7. The supervisory production system of claim 1, with the confirmation input devices including image capturing devices.

8. The supervisory production system of claim 1, with the confirmation input devices including EM readers configured to detect EM tags.

9. The supervisory production system of claim 1, with the confirmation input devices including sensors.

10. The supervisory production system of claim 9, with the sensors including weight sensors, optical sensors, turbidity sensors, pressure sensors, chemical sensors, geographical positioning sensors, time sensors, or fingerprint sensors.

11. The supervisory production system of claim 2, with the control processors programmed to format a plurality of third-party standards and regulations data from a plurality of disparate formats into a uniform assessment format and create assessment nodes using the standards and regulations data in the uniform assessment format,
a. with the assessment nodes designating assessment categories, parameters, and magnitudes.

12. The supervisory production system of claim 11, with the control processors programmed to secure production progress by:
a. comparing production update nodes with the assessment nodes;
b. designating production update nodes as insufficient if the production update nodes do not correspond to the assessment nodes;
c. designating production update nodes as sufficient if the production update nodes correspond to the assessment nodes.

13. The supervisory production system of claim 11, with the control processors programmed to enable production initiation by:
a. comparing production capacity nodes with the assessment nodes;
b. designating production capacity nodes as insufficient if the production capacity nodes do not correspond to the assessment nodes;
c. designating production capacity nodes as sufficient if the production capacity nodes correspond to the assessment nodes.

14. The supervisory production system of claim 1, additionally comprising upstream production systems,
a. with the control processors programmed to track exchanges of circulation data parcels between downstream and upstream production systems, create transitive production capacity nodes and stock the downstream production system profiles with the transitive production capacity nodes;
b. with the transitive production capacity nodes indicating the upstream production systems and the exchanged circulation data parcels.

15. The supervisory production system of claim 13, the control processors programmed to enable production initiation by:
a. designating the available production capacity nodes as insufficient if the available production capacity nodes do not correspond to the production requirement nodes, then determining if the given downstream production system is stocked with production capacity nodes that separately or in concert with the available production capacity nodes do correspond to the production requirement nodes, then designating the available production capacity nodes as transitively sufficient;
b. then designating the production initiation as enabled if the available production capacity nodes are designated as transitively sufficient and the available circulation data parcels are designated as sufficient.

16. The supervisory production system of claim 1, additionally comprising upstream production systems,
a. with the upstream production systems comprising upstream production system data profiles, with the upstream production system data profiles being stocked with upstream production capacity nodes;
b. with the control processor programmed to secure production progress by:
i. if the production update nodes do not correspond to the production progress nodes, identifying upstream production capacity systems having upstream production capacity nodes that separately or in concert with the production capacity nodes correspond to requirement nodes associated with the production progress nodes, and engaging the identified upstream production systems with the downstream production systems.

17. A supervisory production system for tracking, securing, and tokenizing production initiation and production progress, with the supervisory production system comprising:
a. downstream production systems, with the downstream production systems comprising production system processors, production system accounts, and production system data profiles;
b. request systems, with the request systems comprising request system processors, request system accounts, and request system data profiles;
c. circulation data parcels, with the circulation data parcels embedded in cryptocurrency units assigned to production system and request system accounts;
d. production blockchains;
e. confirmation input devices, with the confirmation input devices configured to detect or receive production capacity entries and production update entries;
i. with the production update entries including part, unit, material, or product data, with the part, unit material, or product data including unique identification data and designating a first given downstream production system;
ii. with production update entries being associated with updating accounts responsible for submitting the production update entries;
iii. with a first given circulation data parcel being created for each non-duplicative production update entry and assigned to a first given updating account responsible for submitting the each non-duplicative production update entry;
iv. with the first given circulation data parcel, the each non-duplicative production update entry, and an identity of the assigned first given updating account being saved to the production blockchains;
v. with the production capacity entries including resource, equipment, hardware, software, worker, or user data and designating a second downstream production system;
vi. with production capacity entries being associated with updating accounts responsible for submitting the production capacity entries;
vii. with a second given circulation data parcel being created for each non-duplicative production capacity entry and assigned to a second given updating account responsible for submitting the each non-duplicative production capacity entry;
viii. with the second given circulation data parcel, the each non-duplicative production capacity entry, and an identity of the assigned second given updating account being saved to the production blockchains;
f. a control system, with the control system comprising control processors, with the control processors programmed to:
i. format a plurality of third-party standards and regulations data from a plurality of disparate formats into a uniform assessment format;
ii. receive production update entries from the confirmation input devices;
iii. compare the production update entries with the formatted plurality of third-party standards and regulations data;
iv. designate the unique identification data of production update entries that do not correspond to the formatted plurality of third-party standards and regulations data as non-conforming;
v. compare the production update entries data saved to the production blockchains, and if the production update entries are inconsistent with the data saved to the production blockchains, designate the production update entries as pertaining to a fraudulent part, unit, material, or product and designate a downstream production system responsible for the fraudulent part, unit, material, or product as being in violation;
vi. enable production initiation by:
1. detecting a production initiation between a given request system and a given downstream production system, then detecting production requirements and circulation data parcel requirements associated with the production initiation, available production capacity entries associated with the given downstream production system and available circulation data parcels associated with the given request system;
2. comparing the production requirements with the available production capacity entries;
3. designating the available production capacity entries as sufficient if the available production capacity entries correspond to the production requirements;
4. comparing the circulation data parcel requirements with the available circulation data parcels;
5. designating the available circulation data parcels as sufficient if the circulation data parcel availability data corresponds with the circulation data parcel requirements;
6. if both the available circulation data parcels and the available production capacity nodes are designated as sufficient, and the given downstream production system is not designated as being in violation, then designating the production initiation as enabled;
vii. track production progress by:
1. extracting production progress indicator data from the production requirements;
2. receiving production update entries from the confirmation input devices;
3. comparing production update entries with the production progress data;
4. designating production update entries as insufficient if the production update entries do not correspond to the production progress data;
5. designating production update entries as sufficient if the production update entries correspond to the production progress data;
viii. secure production progress by:
1. if the production update entries are designated as sufficient, then assigning to the production accounts circulation data parcels that were previously assigned to the request accounts according to the circulation data parcel requirements and saving the assignments to the production blockchains; and
2. if the production update entries are designated as insufficient, then assigning to the request accounts circulation data parcels that were previously assigned to the given production accounts according to the circulation data parcel requirements.

18. A supervisory production system for enabling production initiation and tracking and securing production progress, with the supervisory production system comprising:
a. downstream production systems, with the downstream production systems comprising production system processors, production system accounts, and production system data profiles;
b. request systems, with the request systems comprising request system processors, request system accounts, and request system data profiles;
c. circulation data parcels, with the circulation data parcels being assigned to production system and request system accounts;
d. confirmation input devices, with the confirmation input devices configured to detect or receive production capacity entries and production update entries;
e. a control system, with the control system comprising control processors, with the control processors programmed to:
i. receive production capacity entries and production update entries from the confirmation input devices;
ii. match production capacity entries with production capacity nodes, with the production capacity nodes designating capacity categories, parameters, and magnitudes;
iii. stock production system data profiles with the production capacity nodes based on production capacity entries of the downstream production systems;
iv. designate the production capacity nodes as available or unavailable for the production system data profiles;
v. designate the circulation data parcels as available or unavailable for the request system accounts;
vi. enable production initiation by:
1. detecting a production initiation between a given request system and a given downstream production system, then detecting production requirements and circulation data parcel requirements associated with the production initiation, available production capacity nodes associated with the given downstream production system and available circulation data parcels associated with the given request system;
2. entering the production requirements into a first neural network, with first neural network trained to match the production requirements with production requirement nodes, with the neural network configured to detect requirement categories, parameters, and magnitudes;
3. entering the available production capacity nodes in a first input stream of a second neural network and the production requirement nodes in a second stream of the second neural network, with the second neural network configured to detect requirement and capacity categories, parameters, and magnitudes;
a. with the second neural network configured to designate the available production capacity nodes as sufficient if all categories, parameters, and magnitudes of the production requirement nodes can be matched with the categories, parameters, and magnitudes of the available production capacity nodes;
4. comparing the circulation data parcel requirements with the available circulation data parcels;
5. designating the available circulation data parcels as sufficient if the circulation data parcel availability data corresponds with the circulation data parcel requirements;
6. if both the available circulation data parcels and the available production capacity nodes are designated as sufficient, then designating portions of the available circulation data parcels and the available production capacity nodes as unavailable according to the circulation data parcel requirements and production requirement nodes and designating the production initiation as enabled.

19. The supervisory production system of claim 18, with the control processors programmed to track production progress by:
a. entering the production requirement nodes into a third neural network, with the third neural network configured to extract production progress indicator data from the production requirement nodes and to create production progress nodes using the production progress indicator data, with the production progress nodes designating progress categories, parameters, and magnitudes;
b. receiving production update entries from the confirmation input devices, creating production update nodes by combining production update entries, with the production update nodes designating update categories, parameters, and magnitudes;
c. entering the production update nodes and the production progress nodes into a fourth neural network, with the fourth neural network configured to detect update and progress categories, parameters, and magnitudes;
i. with the fourth neural network configured to designate the production progress nodes as sufficient if all categories, parameters, and magnitudes of the production progress nodes can be matched with the categories, parameters, and magnitudes of the production update nodes.

20. The supervisory production system of claim 18, additionally comprising upstream production systems,
a. with the control processors programmed to track exchanges of circulation data parcels between downstream and upstream production systems, create transitive production capacity nodes and stock the downstream production system profiles with the transitive production capacity nodes;
b. with the transitive production capacity nodes indicating the upstream production systems and the exchanged circulation data parcels.
c. with the control processors additionally programmed to enter the transitive production capacity nodes in a third stream of the second neural network,
d. with the second neural network configured to detect transitive production capacity categories, parameters, and magnitudes and designate the available production capacity nodes as transitively sufficient if all categories, parameters, and magnitudes of the production requirement nodes or transitive production capacity nodes can be matched with the categories, parameters, and magnitudes of the available production capacity nodes.
